(19) United States
(12) Patent Application Publication
(10) Pub. No.: US 2016/0266951 A1
(43) Pub. Date: Sep. 15, 2016

(54) DIAGNOSTIC COLLECTOR FOR HADOOP

(71) Applicants: Kumar Swamy BV, Bangalore (IN); W. Michael Rist, JR., Woodbury, MN (US); Waldyn J. Benbenek, Minneapolis, MN (US)

(72) Inventors: Kumar Swamy BV, Bangalore (IN); W. Michael Rist, JR., Woodbury, MN (US); Waldyn J. Benbenek, Minneapolis, MN (US)

(73) Assignee: UNISYS CORPORATION, Blue Bell, PA (US)

(21) Appl. No.: 14/643,040

(22) Filed: Mar. 10, 2015

(51) Int. Cl. G06F 11/07

(52) U.S. Cl. CPC G06F 11/079; G06F 11/0709; G06F 11/0751

(57) ABSTRACT

Systems and methods for identifying a faulty node in a Hadoop cluster using an interface to the Hadoop cluster are described. A method may include receiving, at an interface to a Hadoop cluster, an input requesting diagnostic information for one or more nodes in the Hadoop cluster. The input may also specify the one or more nodes in the Hadoop cluster for which diagnostic information is requested. The method may further include initiating a diagnostic analysis of the one or more nodes, and displaying, at the interface, the diagnostic information for the one or more nodes. The diagnostic information may identify a node exhibiting a fault and be displayed while the diagnostic analysis is in progress.

### FIELD OF THE DISCLOSURE

The instant disclosure relates generally to data storage networks. More specifically, this disclosure relates to management, monitoring, and fault identification of storage entities in data storage networks.

### BACKGROUND

The creation and storage of digitized data has proliferated in recent years. Accordingly, techniques and mechanisms that facilitate efficient and cost effective storage of large amounts of digital data are common today. Typical systems for storage of large amounts of digital data include cluster networks of nodes (generally referred to as storage entities), and data can be distributed across the nodes in one or more clusters. As the amount of data continues to grow rapidly, so does the size of the storage clusters. As a result, management and monitoring of clusters has become a non-trivial task.

One way conventional storage systems manage storage clusters is through a software framework, such as Hadoop. In general, Hadoop is a software framework for storing and processing large amounts of data in a distributed fashion across large clusters of storage entities. However, even with the employment of a high performance software framework for the management of storage clusters, because of the size of conventional cluster networks, identification of a faulty node in a cluster is difficult.

Typically, fault information is recorded as a log file in a node or as a local file in the storage system. Because there is no centralized diagnostic tool for a Hadoop cluster, in order to perform a diagnostic of nodes in a Hadoop cluster, an administrator must first generate an initial report providing initial configuration information for each node in the cluster, then manually fetch the configuration details for faulty nodes from the nodes' or cluster's log files, and finally manually analyze the files to determine if there is a difference between the configurations, which can indicate a node failure and/or the cause of the failure. Not only is the process time consuming, but because manually accessing nodes must be done via command line instructions, an administrator must be familiar with the operating system language as well as Hadoop-specific commands to perform a diagnostic for a cluster. Needless to say, significant drawbacks exist in the management of cluster networks and the identification of faulty nodes in the cluster networks.

### SUMMARY

The identification of a faulty node in a Hadoop cluster may be improved with an interface having access to the Hadoop cluster. According to one embodiment, a method for identifying a faulty node in a Hadoop cluster using an interface to the Hadoop cluster may include receiving, at an interface to a Hadoop cluster, an input requesting diagnostic information for one or more nodes in the Hadoop cluster, wherein the input also specifies the one or more nodes in the Hadoop cluster for which diagnostic information is requested. The method may also include initiating, by the interface, a diagnostic analysis of the one or more nodes. The method may further include displaying, at the interface, the diagnostic information for the one or more nodes, wherein the diagnostic information identifies a node exhibiting a fault, and wherein the diagnostic information is displayed while the diagnostic analysis is in progress. Sample diagnostic informational message may include, for example, “Log files on node16 exceed 40% of the usable space—Suggest harvesting the logs to the server and emptying them;” “Temporary storage use for this job may exceed the available space—New temp storage folder should be added;” and “The number of users supported by the cluster server is at capacity—No new users will be allowed access.” Certain information may cause the administrator to remove nodes from the cluster or to take preventative action. An automated system may also be programmed to take preemptive action if the administrator does not respond in a timely manner.

According to another embodiment, a computer program product may include a non-transitory computer-readable medium comprising code to perform the step of receiving an input requesting diagnostic information for one or more nodes in the Hadoop cluster, wherein the input also specifies the one or more nodes in the Hadoop cluster for which diagnostic information is requested. The medium may also be configured to perform the step of initiating a diagnostic analysis of the one or more nodes. The medium may further be configured to perform the step of displaying the diagnostic information for the one or more nodes, wherein the diagnostic information identifies a node exhibiting a fault, and wherein the diagnostic information is displayed while the diagnostic analysis is in progress.

According to yet another embodiment, an apparatus may include a memory and a processor coupled to the memory. The processor may be configured to execute the step of receiving an input requesting diagnostic information for one or more nodes in the Hadoop cluster, wherein the input also specifies the one or more nodes in the Hadoop cluster for which diagnostic information is requested. The processor may also be configured to execute the step of initiating a diagnostic analysis of the one or more nodes. The processor may be further configured to execute the step of displaying the diagnostic information for the one or more nodes, wherein the diagnostic information identifies a node exhibiting a fault, and wherein the diagnostic information is displayed while the diagnostic analysis is in progress.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the concepts and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed systems and methods, reference is now made to the following descriptions taken in conjunction with the accompanying drawings.

FIG. 1 is a flow chart illustrating a method for identifying a faulty node in a Hadoop cluster using an interface to the Hadoop cluster according to one embodiment of the disclosure.

FIG. 2 is a screen shot illustrating an interface to a Hadoop cluster according to one embodiment of the disclosure.

FIG. 3 is another screen shot illustrating an interface to a Hadoop cluster according to one embodiment of the disclosure.

FIG. 4 is a block diagram illustrating a computer network according to one embodiment of the disclosure.

FIG. 5 is a block diagram illustrating a computer system according to one embodiment of the disclosure.

FIG. 6A is a block diagram illustrating a server hosting an emulated software environment for virtualization according to one embodiment of the disclosure.

FIG. 6B is a block diagram illustrating a server hosting an emulated hardware environment according to one embodiment of the disclosure.

### DETAILED DESCRIPTION

The identification of a faulty node in a Hadoop cluster may be improved with an interface having access to the Hadoop cluster. A faulty node may refer to a node having lower than nominal performance, a node operating at a slower speed than nominal, an inoperable node, or generally any node not operating as expected. Through the use of a user-friendly interface, a user or administrator may monitor and perform diagnostics on cluster networks without extensive knowledge in OS-specific command line instructions or Hadoop-specific commands. To collect diagnostic information on or monitor a cluster, a user or administrator may simply interact with the interface.

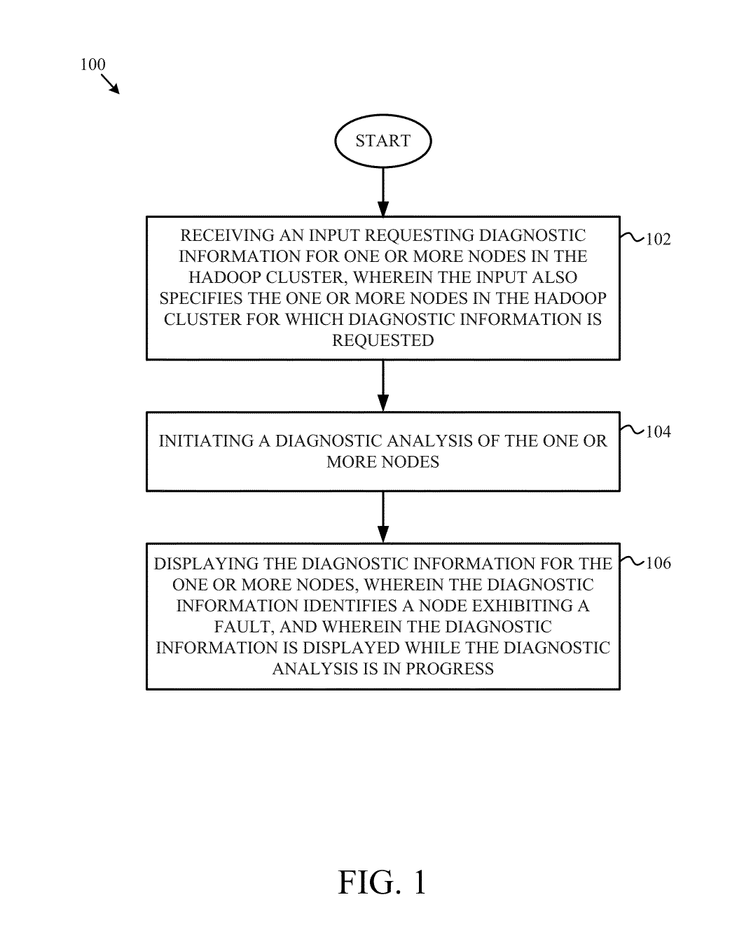

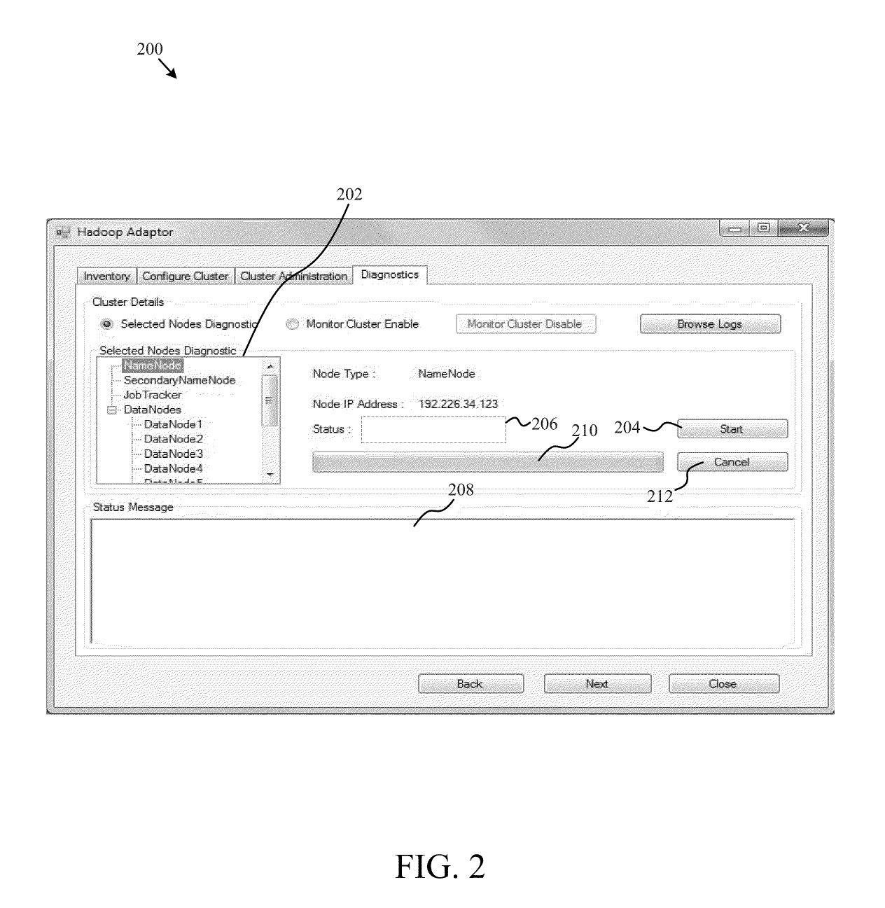

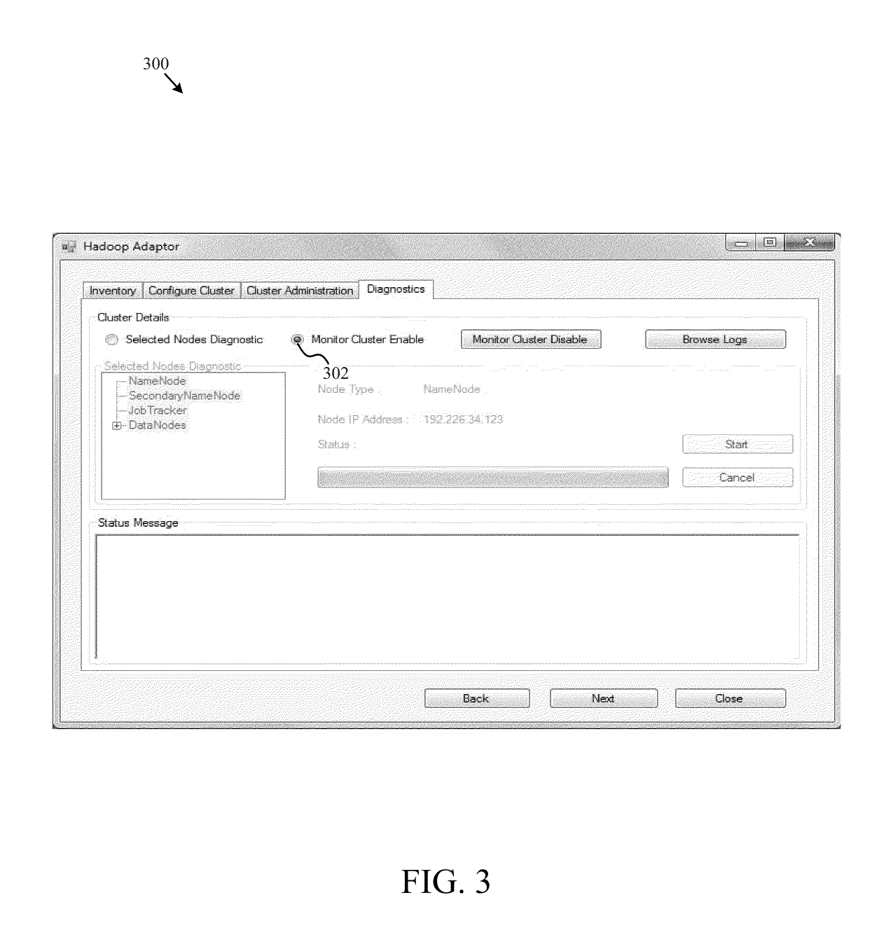

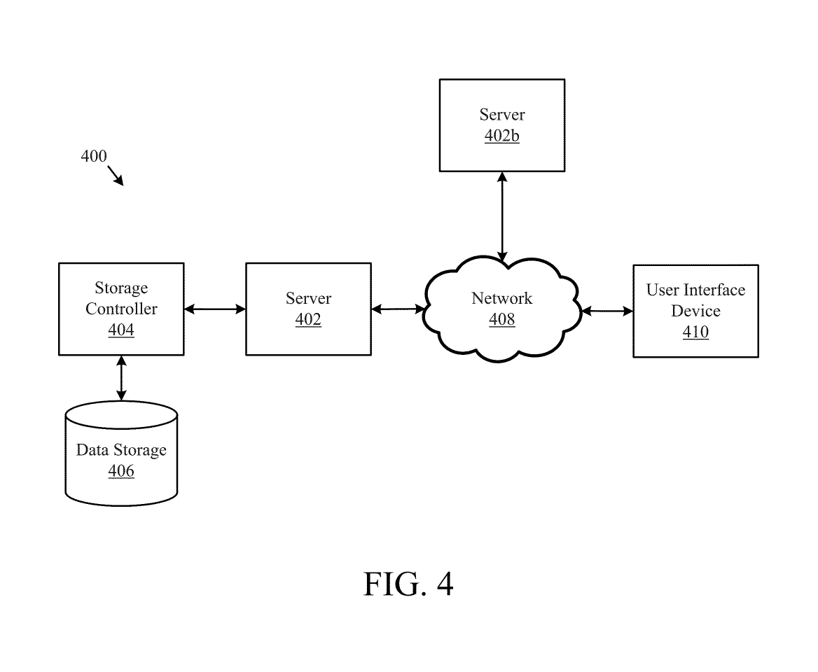

FIG. 1 illustrates a method 100 for identifying a faulty node in a Hadoop cluster using an interface to the Hadoop cluster according to one embodiment of the disclosure. Embodiments of method 100 may be implemented with the interfaces described with respect to FIGS. 2-3 and the systems described with respect to FIGS. 4-6. Specifically, method 100 includes, at block 102, receiving an input requesting diagnostic information for one or more nodes in the Hadoop cluster, wherein the input also specifies the one or more nodes in the Hadoop cluster for which diagnostic information is requested. According to an embodiment, the one or more nodes may include one or more nodes from a single cluster, one or more nodes from multiple clusters, a cluster of nodes, or multiple clusters of nodes. For example, FIG. 2 provides a screen shot illustrating an interface to a Hadoop cluster according to one embodiment of the disclosure. The interface 200 may receive input specifying the one or more nodes in the Hadoop cluster for which to collect diagnostic information via the “Selected Nodes Diagnostic” menu 202. In addition, interface 200 may receive input requesting diagnostic information for the specified one or more nodes in the Hadoop cluster via the “Start” icon 204. As shown, in the “Selected Nodes Diagnostic” menu 202, the specification of one or more nodes may include one or more nodes from a single cluster, one or more nodes from multiple clusters, a cluster of nodes, or multiple clusters of nodes.

Returning to FIG. 1, at block 104, method 100 may include initiating a diagnostic analysis of the one or more nodes. For example, in one embodiment, interface 200 may instruct a processing device in communication with interface 200 and the Hadoop cluster, such as processing devices 402, 502, and 602, to commence diagnostic analysis of the one or more nodes, such as the one or more nodes specified via the “Selected Nodes Diagnostic” menu 202.

Method 100 also includes at block 106 displaying the diagnostic information for the one or more nodes, wherein the diagnostic information identifies a node exhibiting a fault, and wherein the diagnostic information is displayed while the diagnostic analysis is in progress. For example, while the diagnostic is being performed by a processing device, interface 200 may display diagnostic information for a node in the cluster in display region 206 and/or display region 208 of interface 200. According to one embodiment, the diagnostic information displayed at the interface may include individual diagnostic information for at least one of the one or more nodes. According to another embodiment, the diagnostic information displayed at the interface may also include an indication of the completion percentage of the diagnostic analysis of the one or more nodes. For example, in the embodiment illustrated in FIG. 2, status bar 210 may display an indication of the completion percentage of the diagnostic analysis.

In some embodiments, the interface may be configured to receive an input canceling the diagnostic analysis, and the diagnostic analysis may cease when the input cancelling the diagnostic analysis is processed. For example, in the embodiment illustrated in FIG. 2, interface 200 may receive input canceling the diagnostic analysis via the “Cancel” icon 212. Upon receipt of input canceling the diagnostic analysis via the “Cancel” icon 212, the interface may instruct a processor in communication with the interface and performing the diagnostic analysis, such as processing devices 402, 502, and 602, to cease performance of the diagnostic analysis.

According to other embodiments, a processing device coupled to the interface and performing the diagnostic initiated via the interface may detect an error with the diagnostic analysis, and the interface may be configured to, upon detection of the error by the processor, display an error message, such as, for example, in display region 208 of the embodiment illustrated in FIG. 2. According to another embodiment, the interface may also display a button operative to restart the diagnostic information when an error with the diagnostic analysis is detected.

According to some embodiments, the interface may also initiate a monitoring of the performance of at least one node in the Hadoop cluster. For example, FIG. 3 provides a screen shot illustrating another embodiment of an interface to a Hadoop cluster. The interface 300 may receive input requesting the monitoring of the performance of nodes in the cluster via the “Monitor Cluster Enable” button 302. In some embodiments, interface 300 may subsequently instruct a processing device in communication with the interface and the cluster network to commence monitoring of the performance of at least one node in the Hadoop cluster. In some embodiments, a user may also provide input specifying which node, cluster of nodes, or multiple clusters to monitor. For example, as was shown in the embodiment illustrated in FIG. 2, in the “Selected Nodes Diagnostic” menu 202, the specification of one or more nodes may include one or more nodes from a single cluster, one or more nodes from multiple clusters, a cluster of nodes, or multiple clusters of nodes. According to an embodiment, when a node being monitored becomes faulty, the interface may automatically display diagnostic information for the node. For example, as was shown in the embodiment illustrated in FIG. 2, interface 200 may display diagnostic information for a faulty node in the cluster in display region 206 and/or display region 208 of interface 200.

The schematic flow chart diagram of FIG. 1 is generally set forth as a logical flow chart diagram. As such, the depicted order and labeled steps are indicative of one aspect of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

FIG. 4 illustrates a computer network 400 for identifying a faulty node in a Hadoop cluster using an interface to the Hadoop cluster according to one embodiment of the disclosure. The system 400 may include a server 402, a data storage device 406, a network 408, and a user interface device 410. The server 402 may also be a hypervisor-based system executing one or more guest partitions hosting operating systems with modules having server configuration information. In a further embodiment, the system 400 may include a storage controller 404, or a storage server configured to manage data communications between the data storage device 406 and the server 402 or other components in communication with the network 408. In an alternative embodiment, the storage controller 404 may be coupled to the network 408.

In one embodiment, the user interface device 410 is referred to broadly and is intended to encompass a suitable processor-based device such as a desktop computer, a laptop computer, a personal digital assistant (PDA) or tablet computer, a smartphone or other mobile communication device having access to the network 408. In a further embodiment, the user interface device 410 may access the Internet or other wide area or local area network to access a web application or web service hosted by the server 402 and may provide a user interface for enabling a user to enter or receive information.

The network 408 may facilitate communications of data between the server 402 and the user interface device 410. In some embodiments, the network 408 may also facilitate communication of data between the server 402 and other servers/processors, such as server 402b. For example, the network 408 may include a switched fabric computer network communications link to facilitate communication between servers/processors, also referred to as data storage nodes. In some embodiments, the servers 402 and 402b may represent nodes or clusters of nodes managed by a Hadoop software framework. The network 408 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

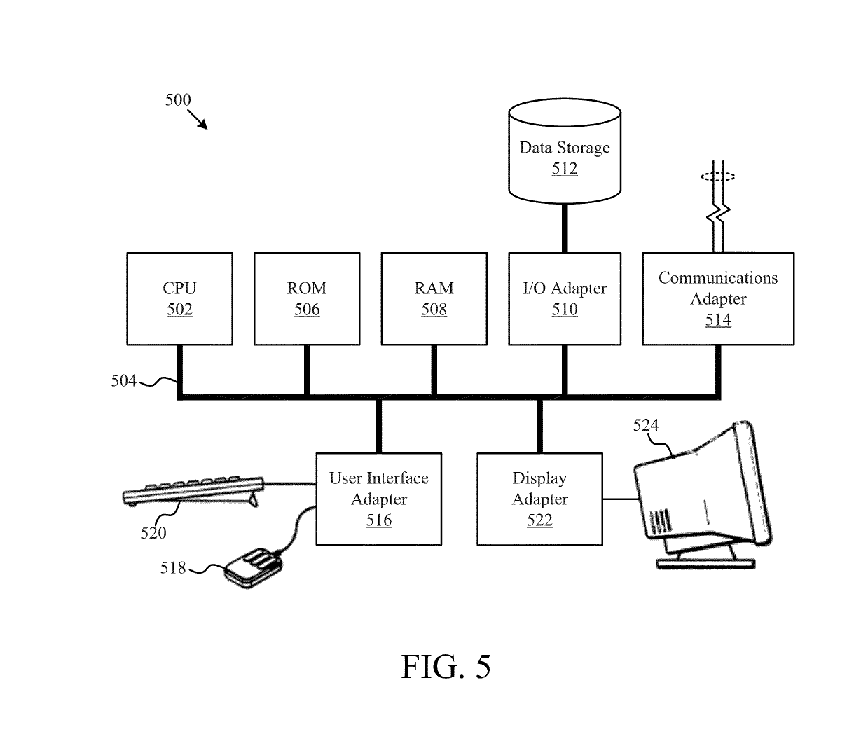

FIG. 5 illustrates a computer system 500 adapted according to certain embodiments of the server 402 and/or the user interface device 410. The central processing unit (“CPU”) 502 is coupled to the system bus 504. The CPU 502 may be a general purpose CPU or microprocessor, graphics processing unit (“GPU”), and/or microcontroller. The present embodiments are not restricted by the architecture of the CPU 502 so long as the CPU 502, whether directly or indirectly, supports the operations as described herein. The CPU 502 may execute the various logical instructions according to the present embodiments.

The computer system 500 may also include random access memory (RAM) 508, which may be synchronous RAM (SRAM), dynamic RAM (DRAM), synchronous dynamic RAM (SDRAM), or the like. The computer system 500 may utilize RAM 508 to store the various data structures used by a software application. The computer system 500 may also include read only memory (ROM) 506 which may be PROM, EPROM, EEPROM, optical storage, or the like. The ROM may store configuration information for booting the computer system 500. The RAM 508 and the ROM 506 hold user and system data, and both the RAM 508 and the ROM 506 may be randomly accessed.

The computer system 500 may also include an input/output (I/O) adapter 510, a communications adapter 514, a user interface adapter 516, and a display adapter 522. The I/O adapter 510 and/or the user interface adapter 516 may, in certain embodiments, enable a user to interact with the computer system 500. In a further embodiment, the display adapter 522 may display a graphical user interface (GUI) associated with a software or web-based application on a display device 524, such as a monitor or touch screen.

The I/O adapter 510 may couple one or more storage devices 512, such as one or more of a hard drive, a solid state storage device, a flash drive, a compact disc (CD) drive, a floppy disk drive, and a tape drive, to the computer system 500. According to one embodiment, the data storage 512 may be a separate server coupled to the computer system 500 through a network connection to the I/O adapter 510. The communications adapter 514 may be adapted to couple the computer system 500 to the network 408, which may be one or more of a LAN, WAN, and/or the Internet. The user interface adapter 516 couples user input devices, such as a keyboard 520, a pointing device 518, and/or a touch screen (not shown) to the computer system 500. The display adapter 522 may be driven by the CPU 502 to control the display on the display device 524. Any of the devices 502-522 may be physical and/or logical.

The applications of the present disclosure are not limited to the architecture of computer system 500. Rather the computer system 500 is provided as an example of one type of computing device that may be adapted to perform the functions of the server 402 and/or the user interface device 510. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 500 may be virtualized for access by multiple users and/or applications.

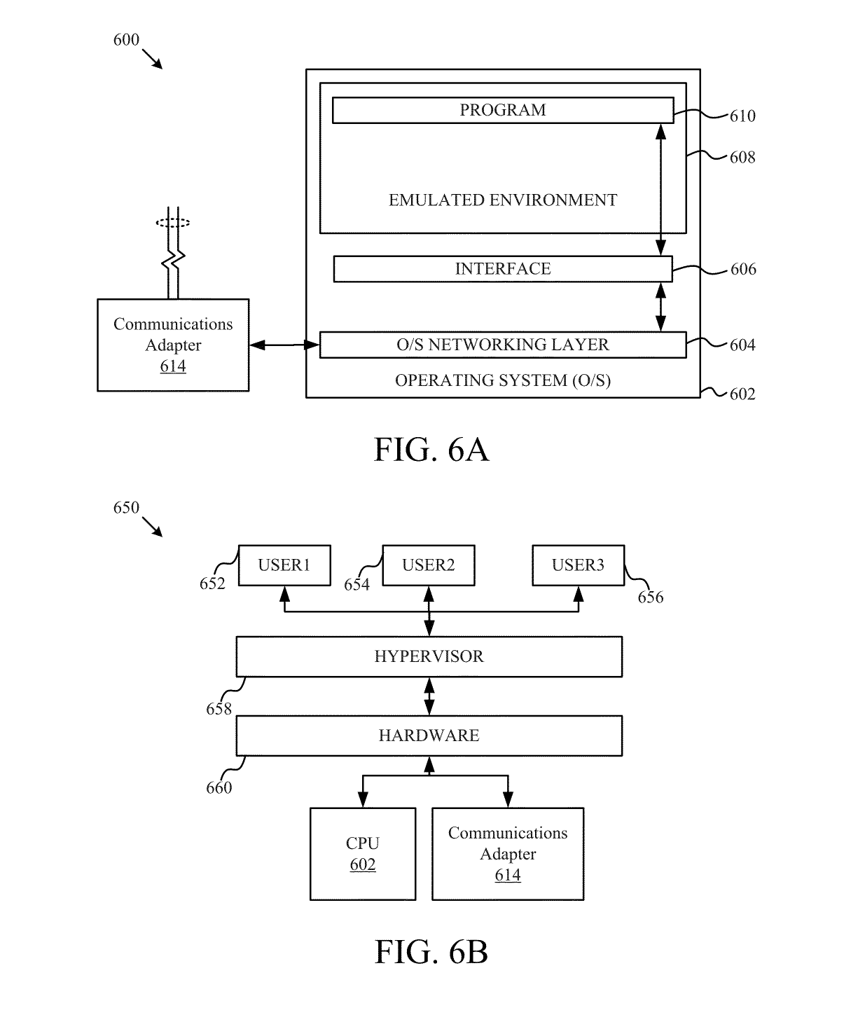

FIG. 6A is a block diagram illustrating a server hosting an emulated software environment for virtualization according to one embodiment of the disclosure. An operating system 602 executing on a server includes drivers for accessing hardware components, such as a networking layer 604 for accessing the communications adapter 614. The operating system 602 may be, for example, Linux or Windows. An emulated environment 608 in the operating system 602 executes a program 610, such as Communications Platform (CPComm) or Communications Platform for Open Systems (CPCommOS). The program 610 accesses the networking layer 604 of the operating system 602 through a non-emulated interface 606, such as extended network input output processor (XNIOP). The non-emulated interface 606 translates requests from the program 610 executing in the emulated environment 608 for the networking layer 604 of the operating system 602.

In another example, hardware in a computer system may be virtualized through a hypervisor. FIG. 6B is a block diagram illustrating a server hosting an emulated hardware environment according to one embodiment of the disclosure. Users 652, 654, 656 may access the hardware 660 through a hypervisor 658. The hypervisor 658 may be integrated with the hardware 660 to provide virtualization of the hardware 660 without an operating system, such as in the configuration illustrated in FIG. 6A. The hypervisor 658 may provide access to the hardware 660, including the CPU 602 and the communications adaptor 614.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method for identifying a faulty node in a Hadoop cluster using an interface to the Hadoop cluster, comprising:
receiving, at an interface to a Hadoop cluster, an input requesting diagnostic information for one or more nodes in the Hadoop cluster, wherein the input also specifies the one or more nodes in the Hadoop cluster for which diagnostic information is requested;
initiating, by the interface, a diagnostic analysis of the one or more nodes; and
displaying, at the interface, the diagnostic information for the one or more nodes,
wherein the diagnostic information identifies a node exhibiting a fault, and wherein the diagnostic information is displayed while the diagnostic analysis is in progress.

2. The method of claim 1, wherein the diagnostic information displayed at the interface comprises at least one of individual diagnostic information for at least one of the one or more nodes and an indication of the completion percentage of the diagnostic analysis of the one or more nodes.

3. The method of claim 1, wherein the one or more nodes comprise a cluster of nodes.

4. The method of claim 1, further comprising receiving an input canceling the diagnostic analysis, wherein the diagnostic analysis ceases when the input cancelling the diagnostic analysis is processed.

5. The method of claim 1, further comprising:
detecting an error with the diagnostic analysis; and
displaying, at the interface, upon detecting the error, an error message and a button operative to restart the diagnostic analysis.

6. The method of claim 1, further comprising:
initiating a monitoring of performance of at least one node in the Hadoop cluster, and
automatically displaying diagnostic information for a node being monitored when the node becomes faulty.

7. A computer program product, comprising:
a non-transitory computer-readable medium comprising instructions which, when executed by a processor of a computing system, cause the processor to perform the steps of:
receiving an input requesting diagnostic information for one or more nodes in the Hadoop cluster, wherein the input also specifies the one or more nodes in the Hadoop cluster for which diagnostic information is requested;
initiating a diagnostic analysis of the one or more nodes; and
displaying the diagnostic information for the one or more nodes, wherein the diagnostic information identifies a node exhibiting a fault, and wherein the diagnostic information is displayed while the diagnostic analysis is in progress.

8. The computer program product of claim 7, wherein the diagnostic information displayed at the interface comprises at least one of individual diagnostic information for at least one of the one or more nodes and an indication of the completion percentage of the diagnostic analysis of the one or more nodes.

9. The computer program product of claim 7, wherein the one or more nodes comprise a cluster of nodes.

10. The computer program product of claim 7, wherein the medium further comprises instructions to cause the processor to perform the step of receiving an input canceling the diagnostic analysis, wherein the diagnostic analysis ceases when the input cancelling the diagnostic analysis is processed.

11. The computer program product of claim 7, wherein the medium further comprises instructions to cause the processor to perform the steps of:
detecting an error with the diagnostic analysis; and
displaying, upon detecting the error, an error message and a button operative to restart the diagnostic analysis.

12. The computer program product of claim 7, wherein the medium further comprises instructions to cause the processor to perform the steps of:
initiating a monitoring of performance of at least one node in the Hadoop cluster, and
automatically displaying diagnostic information for a node being monitored when the node becomes faulty.

13. An apparatus, comprising:
a memory; and
a processor coupled to the memory, the processor configured to execute the steps of:
receiving an input requesting diagnostic information for one or more nodes in the Hadoop cluster, wherein the input also specifies the one or more nodes in the Hadoop cluster for which diagnostic information is requested;
initiating a diagnostic analysis of the one or more nodes; and
displaying the diagnostic information for the one or more nodes, wherein the diagnostic information identifies a node exhibiting a fault, and wherein the diagnostic information is displayed while the diagnostic analysis is in progress.

14. The apparatus of claim 13, wherein the diagnostic information displayed at the interface comprises at least one of individual diagnostic information for at least one of the one or more nodes and an indication of the completion percentage of the diagnostic analysis of the one or more nodes.

15. The apparatus of claim 13, wherein the one or more nodes comprise a cluster of nodes.

16. The apparatus of claim 13, wherein the processor is further configured to perform the step of receiving an input canceling the diagnostic analysis, wherein the diagnostic analysis ceases when the input cancelling the diagnostic analysis is processed.

17. The apparatus of claim 13, wherein the processor is further configured to perform the steps of:
detecting an error with the diagnostic analysis; and
displaying, upon detecting the error, an error message and a button operative to restart the diagnostic analysis.

18. The apparatus of claim 13, wherein the processor is further configured to perform the steps of:
initiating a monitoring of performance of at least one node in the Hadoop cluster, and
automatically displaying diagnostic information for a node being monitored when the node becomes faulty.
